(19) United States
(12) Patent Application Publication
(10) Pub. No.: US 2024/0320953 A1
(43) Pub. Date: Sep. 26, 2024

(54) METHODS AND APPARATUS FOR EXPLAINABLE MULTI-SCALE GAUSSIAN MIXTURE MODEL DISTANCE

(71) Applicant: Intel Corporation, Santa Clara, CA (US)

(72) Inventors: Anthony Rhodes, Portland, OR (US); Ilke Demir, Hermosa Beach, CA (US); Yali Bian, Fremont, CA (US)

(21) Appl. No.: 18/677,473

(22) Filed: May 29, 2024

Related U.S. Application Data
(60) Provisional application No. 63/566,011, filed on Mar. 15, 2024.

(51) Int. Cl. G06V 10/74; G06V 10/46

(52) U.S. Cl. CPC G06V 10/761; G06V 10/462

(57) ABSTRACT

An example apparatus includes interface circuitry, machine-readable instructions, and at least one processor circuit to be programmed by the machine-readable instructions to access a first saliency map and a second saliency map associated with an image dataset, encode pixel-level intensity of the first saliency map, encode pixel-level intensity of the second saliency map, generate a saliency comparison metric based on the pixel-level intensity of the first saliency map and the pixel-level intensity of the second saliency map, and compare spatial properties of the first saliency map and the second saliency map using the saliency comparison metric.

### RELATED APPLICATION

This patent claims the benefit of U.S. Provisional Patent Application No. 63/566,011, filed Mar. 15, 2024, entitled “Explainable Multi-Scale Gaussian Mixture Model Distance.” The entire disclosure U.S. Provisional Patent Application No. 63/566,011 is hereby incorporated by reference in its entirety.

### BACKGROUND

Explainable artificial intelligence (XAI) represents a set of processes and methods used to describe AI-based models (e.g., expected impact, potential biases, etc.). For example, XAI characterizes model outcome, accuracy, and transparency as applied to AI-based decision making. As such, XAI can be used to understand how an AI system reached a particular decision, recommendation, and/or prediction. Highly complex and opaque machine learning models benefit from XAI methods for improving model explainability.

### BRIEF DESCRIPTION OF THE DRAWINGS

FIG. 1A illustrates saliency map processing and fitting of a weighted data Gaussian mixture model (GMM) to processed saliency maps using example model saliency comparator circuitry.

FIG. 1B illustrates generation of a fine-grain saliency comparison metric capturing diverse spatial properties using the model saliency comparator circuitry of FIG. 1.

FIG. 2 illustrates an example detector saliency comparison using saliencies aggregated over four different XAI-based methods and compared among seven detectors.

FIG. 3A illustrates an example generator saliency comparison using saliencies aggregated over four different XAI-based methods and compared using a structural similarity index measure (SSIM).

FIG. 3B illustrates an example generator saliency comparison using saliencies aggregated over four different XAI-based methods and compared using Kullback-Leibler (KL) divergence.

FIG. 3C illustrates an example generator saliency comparison using saliencies aggregated over four different XAI-based methods and compared using the explainable multi-scale GMM distance (XGMD) metric disclosed herein.

FIG. 4 illustrates example saliency maps generated using seven detectors and four saliency methods for a specific frame.

FIG. 5A illustrates an example first saliency map generated using a first detector (Inception) and a first generator (Deepfakes) when evaluated using KL-divergence scores.

FIG. 5B illustrates an example second saliency map generated using a second detector (SqueezeNet) and a first generator (Deepfakes) when evaluated using KL-divergence scores.

FIG. 5C illustrates an example third saliency map generated using a second detector (SqueezeNet) and a second generator (NeuralTextures) when evaluated using KL-divergence scores.

FIG. 5D illustrates an example fourth saliency map generated using a first detector (Inception) and a first generator (Deepfakes) when evaluated using the explainable multi-scale GMM distance (XGMD) metric disclosed herein.

FIG. 5E illustrates an example fifth saliency map generated using a second detector (SqueezeNet) and a first generator (Deepfakes) when evaluated using the XGMD metric disclosed herein.

FIG. 5F illustrates an example sixth saliency map generated using a second detector (SqueezeNet) and a second generator (NeuralTextures) when evaluated using the XGMD metric disclosed herein.

FIG. 6 is a block diagram representative of the model saliency comparator circuitry of FIGS. 1A-1B.

FIG. 7 is a flowchart representative of example machine-readable instructions and/or example operations that may be executed, instantiated, and/or performed by example programmable circuitry to implement the example model saliency comparator circuitry of FIGS. 1A-1B.

FIG. 8 is a flowchart representative of example machine-readable instructions and/or example operations that may be executed, instantiated, and/or performed by example programmable circuitry to implement the example model saliency comparator circuitry of FIGS. 1A-1B to encode pixel-level intensity of saliency maps using fitting of weighted Gaussian mixture models (GMMs).

FIG. 9 is a block diagram of an example processing platform including programmable circuitry structured to execute, instantiate, and/or perform the example machine readable instructions and/or perform the example operations of FIGS. 7-8 to implement the model saliency comparator circuitry of FIGS. 1A-1B.

FIG. 10 is a block diagram of an example implementation of the processor circuitry of FIG. 9.

FIG. 11 is a block diagram of another example implementation of the programmable circuitry of FIG. 9.

FIG. 12 is a block diagram of an example software/firmware/instructions distribution platform (e.g., one or more servers) to distribute software, instructions, and/or firmware (e.g., corresponding to the example machine readable instructions of FIGS. 7-8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

The field of Explainable Artificial Intelligence (XAI) focuses on AI model interpretability by making complex models such as deep neural networks (DNNs) transparent and understandable to users. XAI is rapidly growing in importance and maturity in parallel with new innovations across AI and machine learning (ML) domains, demonstrating a renewed emphasis on trust and interpretability of state-of-the-art (SOTA) models. For example, diffusion models (DMs) represent a best-in-class image synthesis technique (e.g., DALLE-2, Imagen, Chat-GPT4, etc.), but many fundamental explainable aspects of DMs remain opaque. XAI can be used to generate visualizations while also providing counterfactual explanations, feature attributions, and/or rule-based explanations. In some examples, saliency maps generated by XAI serve as a form of a visual explanation indicating which input features were used by an AI model to generate the model's output decisions. Image-based explanations are evaluated and compared using regular image similarity metrics, distribution similarity, or a change of model accuracy when the input pixels are modified according to the visual explanation.

With the increasing complexity and influence of machine learning models, the development of AI model explanation techniques has gained significant attention. These techniques aim to provide valuable insights into the inner workings of AI-based models. The diversity of approaches in this field has led to categorizations based on their distinctive characteristics, such as global or local explanations. Global explanation methods (e.g., such as Shapley additive explanation values (SHAP)) provide insight into a model's behavior across the entire input space. In contrast, local explanation methods (e.g., local interpretable model-agnostic explanations (LIME)) focus on elucidating model decisions for individual data points or small subsets of data, offering fine-grained insights into model behavior. For example, saliency methods (e.g., generation of saliency maps) are a widely adopted and valuable approach for interpreting neural networks. Saliency maps provide insight into a model's prediction behavior to understand how different conditions affect the model's performance. For example, saliency maps are heatmaps that visualize the importance of each pixel in an input image with respect to the prediction of a particular output class, such that the visualization provides an assessment of which parts of an image caused the model to recognize an object of a given class.

Example methods and apparatus disclosed herein introduce an explainability-based comparison metric (e.g., explainable multi-scale Gaussian mixture model (GMM) distance (XGMD) metric) that can be used to compare model saliencies. In examples disclosed herein, the XGMD metric uses pixels and a reduced number of parameters, includes both spatial and distributional understanding, and is sufficiently robust to saliency noise. In examples disclosed herein, flexible GMMs learn a high-order probability distribution in the input pixel space at multiple scales for each input saliency comparison. In examples disclosed herein, a 2-Wasserstein distance is determined between the GMMs (e.g., one pair for each input scale) to determine an explainability-forward similarity between the saliences. Compared to conventional visual Explainable Artificial Intelligence (XAI)-based metrics, the XGMD metric is less sensitive to individual input/pixel saliency anomalies and, therefore, more robust as an explainable similarity measure due to the use of a high-order distribution (e.g., application of KL divergence to perform discrete, pixel-level calculations). The XGMD metric disclosed herein is also less sensitive to dataset size, given that known score-based methods show poor convergence properties on smaller datasets.

Example methods and apparatus disclosed herein introduce a high-level XGMD workflow that receives saliency maps or aggregations of saliency maps as inputs representing different models or datasets. The XGMD metric quantifies similarity and/or dissimilarity between the different machine learning models and datasets based on the input saliency maps. Some example methods and apparatus disclosed herein permit quantification of XAI-based similarity and/or dissimilarity for structured tasks based on the XGMD metric (e.g., feature detection with spatial normalization). In contrast to other image similarity metrics, example methods and apparatus disclosed herein generate a robust measure by mapping the similarity calculation to a set of multi-scale, higher-order probability distributions (e.g., multi-scale GMMs) in place of traditionally more sensitive features such as individual pixel intensities. In examples disclosed herein, a weighted-GMM fitting is performed to encode the pixel-level intensity of saliency maps or sets of saliency maps using a data point duplication process. Example methods and apparatus disclosed herein improve AI model explainability and trust for real-world use cases with synthetic data, including applications such as deepfake detection and/or analysis (e.g., identification of synthetic media that has been digitally manipulated, etc.). Example methods and apparatus disclosed herein can be applied to any deep learning model and/or dataset, including general predictive modeling domains outside of computer vision.

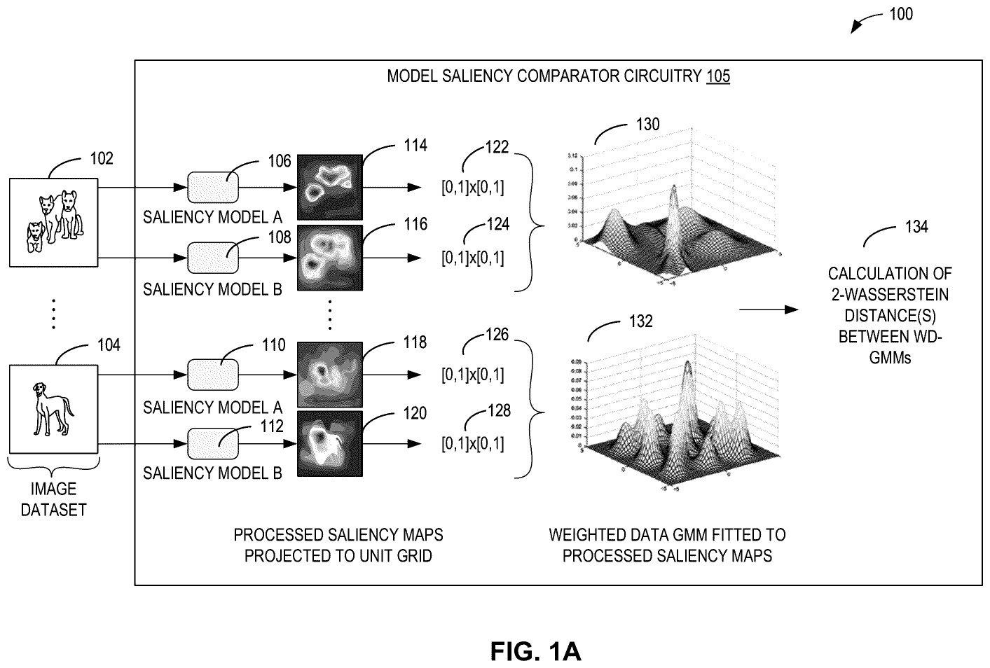

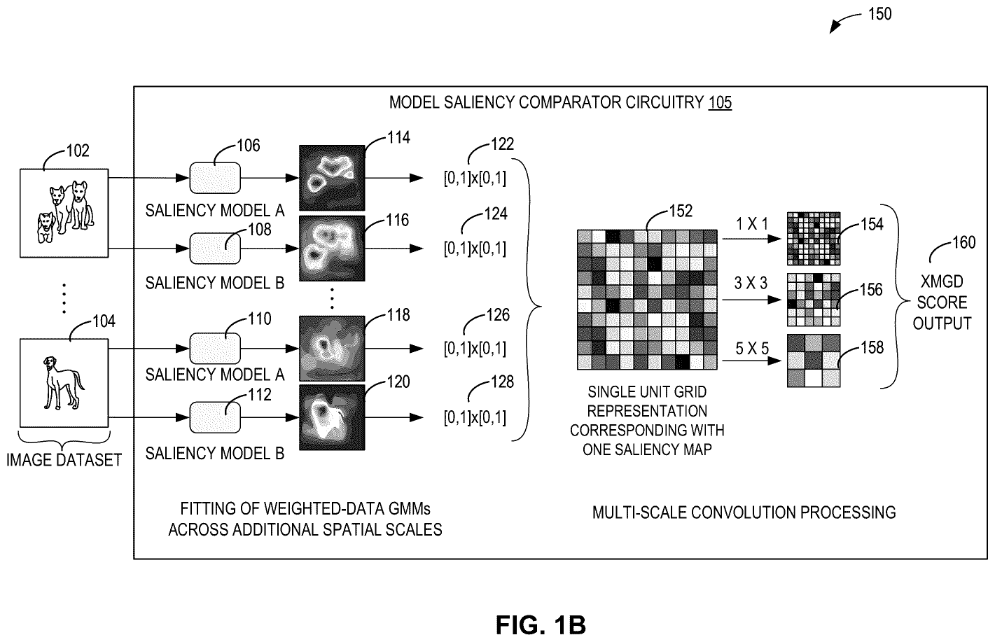

FIG. 1A illustrates an example workflow 100 including saliency map processing and fitting of a weighted data Gaussian mixture model (GMM) to each of the processed saliency maps using example model saliency comparator circuitry 105. In the example of FIG. 1A, the model saliency comparator circuitry 105 receives input image dataset(s) 102, 104. For example, given two sets of saliency images, or aggregations of saliency images, the model saliency comparator circuitry 105 calculates a mean, per-pixel saliency across the set of images associated with the input image dataset(s) 102, 104. For example, the model saliency comparator circuitry 105 identifies the mean, per-pixel saliency across the set of saliency images (e.g., saliency images S^{I} and S^{J}) using S^{I}⊃sⁱ:i≤|I| and S^{J}⊃s^{j}:j≤|J| based on a min-max normalization, such that S^{I}, S^{J}∈[0,1]^{w×h}, resulting in pixel values normalized to [0,1], where w and h correspond to the image width and height, respectively. In the example of FIG. 1A, the model saliency comparator circuitry 105 uses saliency model(s) 106, 108 to generate saliency maps 114, 116 based on the input image dataset 102 and saliency model(s) 110, 112 to generate saliency maps 118, 120 based on the input image dataset 104. Image saliency models can be identified from scene images alone by combining local contrasts in low-level, pre-semantic image features (e.g., color, luminance, orientation across spatial scales, etc.). For example, a brightly colored object is a region that would be predicted by an image saliency model to capture attention. The model saliency comparator circuitry 105 projects the processed saliency maps to a unit grid (e.g., saliency map(s) 114, 116 are projected to unit grid(s) 122, 124 and saliency map(s) 118, 120 are projected to unit grid(s) 126, 128). Subsequently, the model saliency comparator circuitry 105 trains a data weighted GMM to fit each saliency image. For example, the model saliency comparator circuitry 105 transforms each saliency image into a corresponding dataset in the input pixel space.

As shown in connection with FIG. 1A, the model saliency comparator circuitry 105 of this example converts pixels (e.g., each pixel) in the saliency image to a unit grid (e.g., [0,1]×[0,1]) and determines per-pixel normalized saliency values as a data weight. For example, if pixel xₘₙ∈S¹ (e.g., where xₘₙ refers to a pixel in image S^{I} with a coordinate location of (m, n)) has a normalized saliency score identified as Sₘₙ^{I}, the model saliency comparator circuitry 105 maps this weight to the corresponding pixel in the unit grid (e.g., using unit grid(s) 122, 124, etc.). In some examples, the solution for weighted-GMMs is equivalent to a duplicated point GMM, where data points are duplicated in correspondence with data weights and solved using a classical expectation-maximization (EM) approach. In examples disclosed herein, the model saliency comparator circuitry 105 duplicates data points by introducing a tunable binning parameter b, such that

$${n}_{ij} = ⌊ \frac{{s}_{ij}}{b} ⌋ ,$$

where nᵢⱼ denotes the number of data point duplications for an example data point xᵢⱼ.

Once the dataset corresponds to spatial saliency defined over the unit grid with duplicated points, the model saliency comparator circuitry 105 performs a fitting of the GMMs using the EM algorithm for each of the two input saliency images S^{I} and S^{J}, denoted as a first GMM (P) and a second GMM (Q). For example, the model saliency comparator circuitry 105 defines the first GMM as P=Σᵢ₌₁^{K}^{₀}πᵢνᵢ and the second GMM as Q=Σᵢ₌₁^{K}^{₁}αᵢμᵢ, where ∀i∈{1, . . . , K₀}, ∀j∈{1, . . . , K₁}. For example, P and Q refer to two Gaussian mixture models (e.g., with K₀ and K₁ Gaussians in each model, respectively), where πᵢ and αᵢ are mixing parameters, νᵢ represents a mean of the ith mixture from the first GMM (P), and μᵢ represents a mean of the ith mixture from the second GMM (Q). In the example of FIG. 1A, once the model saliency comparator circuitry 105 performs fitting of the weighted data GMMs to processed saliency maps (e.g., generating Gaussian mixture model(s) 130, 132), the model saliency comparator circuitry 105 generates a calculation of 2-Wasserstein distance(s) based on the weighted-data GMMs (e.g., distance calculation 134 of FIG. 1A). In examples disclosed herein, the model saliency comparator circuitry 105 calculates the mixed 2-Wasserstein distance in accordance with Equations 1-2, where the distance is calculated in closed form:

$$M {W}^{2} ( P , Q ) = {min}_{γ} {\sum }_{i , j} {γ}_{ij} {W}_{2}^{2} ( {v}_{i} , {μ}_{j} ) \qquad Equation 1$$

$${W}_{2}^{2} ( N ( {μ}_{1} , {\sum }_{1} ) , N ( {μ}_{2} , {\sum }_{2} ) ) = {‖ {μ}_{1} - {μ}_{2} ‖}_{2}^{2} + Tr ( {\sum }_{1} ) + Tr ( {\sum }_{2} ) - 2 {Tr ( {\sum }_{1}^{\frac{1}{2}} {\sum }_{2} {\sum }_{1}^{\frac{1}{2}} )}^{1 / 2} \qquad Equation 2$$

In the example of Equation 1, γ can be solved using discrete optimal transport (e.g., using efficient Python solvers for both GMM fitting and optimal transport). The 2-Wasserstein distance provides a scalar value to quantify the similarity of two Gaussian distributions. For example, one comparison can take approximately one minute for saliency images of size (256, 256).

FIG. 1B illustrates an example workflow 200 including generation of a fine-grain saliency comparison metric capturing diverse spatial properties using the model saliency comparator circuitry 105 of FIG. 1. In the example of FIG. 1B, the model saliency comparator circuitry 105 repeats the calculations of FIG. 1A (e.g., generation of saliency model(s) 106, 108 based on saliency maps 114, 116, conversion of each pixel in the saliency image(s) to unit grid(s) 122, 124). Additionally, in order to generate a more fine-grained saliency comparison metric capturing spatial properties, the model saliency comparator circuitry 105 determines a mixed 2-Wasserstein distance (e.g., MW²(P, Q)) across l spatial scales, using l−1 and two-dimensional (2D) convolutions with kernel sizes {C_{w}×C_{w}, C_{2×w-1}×C_{2×w-1}, . . . } on saliency maps, respectively. The kernel sizes refer to kernels used in a convolution operation. For example, standard kernel sizes can include 3×3, 5×5, and/or 7×7 kernel sizes, where a kernel size of 3×3 refers to a sub-image of 3 pixels by 3 pixels. As such, when sampling an image and/or a saliency map, a sub-image of the kernel size is cropped (e.g., to yield a kernel size of 3×3, 5×5, etc. as shown in connection with FIG. 1B). The different kernel sizes capture different spatial scales in the saliency map for comparison. Leveraging more spatial scales in this way can lead to a more robust saliency comparison measure. In the example of FIG. 1B, the model saliency comparator circuitry 105 identifies the final XMGD score using

$$\frac{1}{l} {\sum }_{l} M {W}_{l}^{2} ( {P}_{l} , {Q}_{l} )$$

as the average of the distances from all levels of distances between distribution. The number of levels l, sizes of convolution kernels w, number of bins b, and number of Gaussians for the GMM fit can be tunable per domain, dataset, and/or image size. In examples disclosed herein, a level of l=3 is used, such that the model saliency comparator circuitry 105 applies convolutions to the original saliency images (e.g., using kernel sizes 5×5 and 3×3) to determine the explainable multi-scale GMM distance (XGMD) metric. In the example of FIG. 1B, a single unit grid representation 152 is shown corresponding with one saliency map, with multi-scale convolutions (e.g., applying kernel sizes 1×1, 5×5, etc.) used to aggregate information in the saliency images, yielding smaller resolution single unit grid output(s) 154, 156, 158. Subsequently, the model saliency comparator circuitry 105 identifies an XMGD score output 160 based on the GMM fittings performed for each spatial scale (e.g., using single unit grid output(s) 154, 156, 158) and the identification of an average 2-Wasserstein distance across the spatial scales.

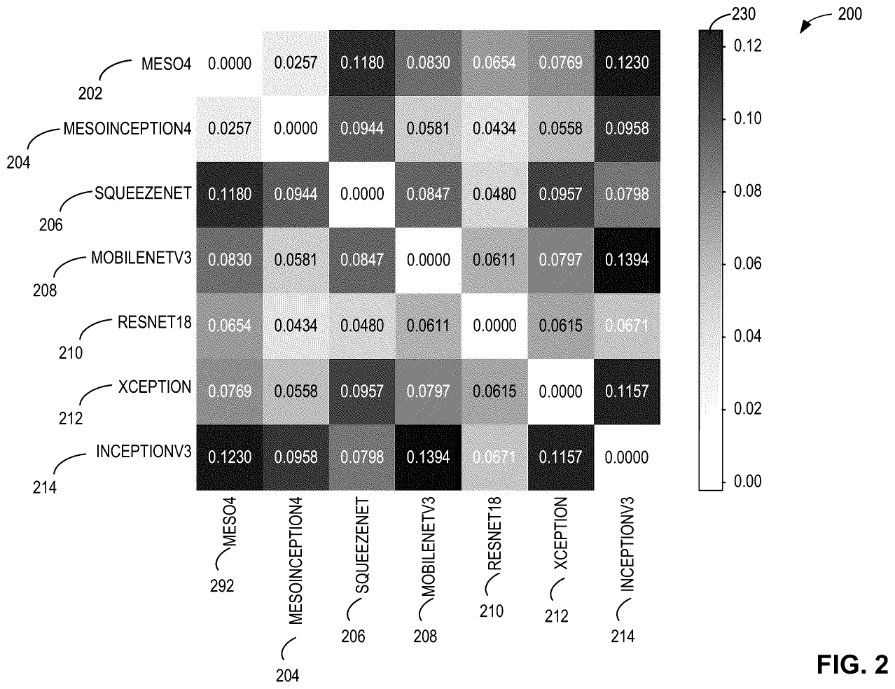

FIG. 2 illustrates an example detector saliency comparison 200 using saliencies aggregated over four different XAI-based methods and compared among seven detectors. As described in connection with FIGS. 1A-1B, the model saliency comparator circuitry 105 pre-processes input saliency maps (e.g., given at least two input saliency maps, aggregations of saliency maps, etc.) representing different models or datasets and projects the saliency maps to a 2D unit grid, fits a weighted-data GMM (WD-GMM) to each of the two processed saliency maps, calculates a 2-Wasserstein distance between the WD-GMMs, and repeats this method across additional spatial scales by introducing a convolution operation to generate a fine-grain saliency comparison metric (e.g., XMGD score output 160) capturing the spatial properties. As such, the XMGD score output is an XAI-based metric used to quantify the similarity and/or dissimilarity between and/or among different machine learning models and/or datasets. In the example of FIG. 2, the model saliency comparator circuitry 105 evaluates the explainable multi-scale GMM distance (XGMD) by comparing the distance's representativeness in terms of (1) diversity of distances, (2) relevance to model-based metrics, and/or (3) preserved correlations of detectors/generators. In the example of FIG. 2, experimental results are shown generated across seven Deepfake detectors (e.g., Meso4 202, MesoInception4 204, SqueezeNet 206, MobileNetv3 208, ResNet18 210, Xception 212, Inceptionv3 214) trained on real and fake classes using an available dataset (e.g., FaceForensics++ dataset, etc.) based on saliency maps aggregated over four different methods. For example, the saliency maps are aggregated based on their Kullback-Leibler (KL) divergence scores. In the example of FIG. 2, differences in the distance scores (e.g., distance comparison 230) indicate saliency differences when comparing various detectors.

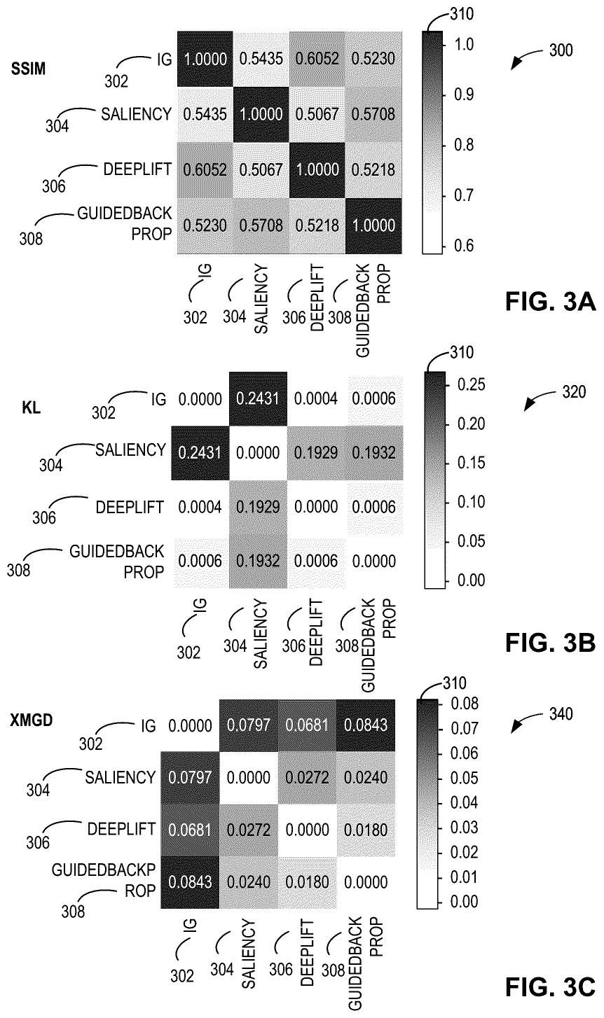

FIGS. 3A-3C illustrate example generator saliency comparison(s) 300, 320, 340 using saliencies aggregated over four different XAI-based methods and compared among seven detectors. In the example of FIGS. 3A-3C, the four different XAI-based methods include IG 302, Saliency 304, Deeplift 306, and Guidedback prop 308, which are assessed using distance comparison 310. In the example of FIG. 3A, the aggregated saliency maps are compared using a structural similarity index measure (SSIM) (e.g., shown using generator saliency comparison 300). In the example of FIG. 3B, the aggregated saliency maps are compared using a KL divergence (e.g., shown using generator saliency comparison 320). In the example of FIG. 3C, the aggregated saliency maps are compared using the XMGD metric disclosed herein (e.g., shown using generator saliency comparison 340). In examples disclosed herein, XMGD (e.g., shown using generator saliency comparison 340) demonstrates the most different levels of distances between distributions, supporting the diversity of distances evaluation. For example, this evaluation is based on the observation that better distribution transports are modeled by fitting to higher order distributions. When comparing results for model-dependent saliency metrics and the results of FIGS. 3A-3C (e.g., as part of evaluating the XGMD metric by identifying relevance to model-based metrics), similar differentiation of Integrated Gradients (IG) is observed from other models, by both XMGD and three model-based metrics. A such, these results indicate that XMGD can capture model-based importance without the need for input manipulation and running inference.

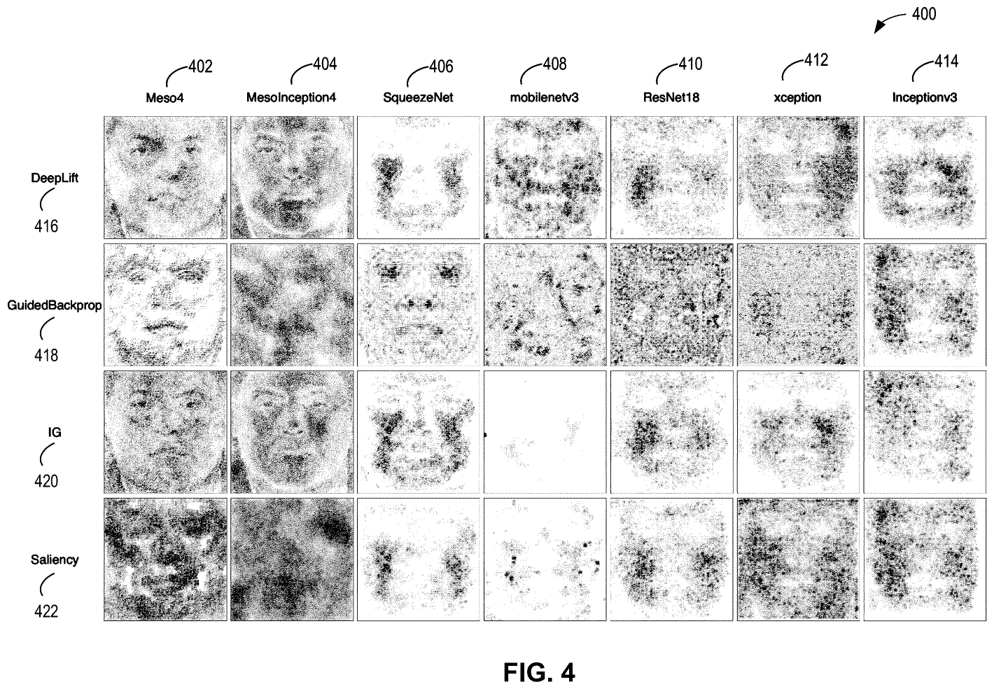

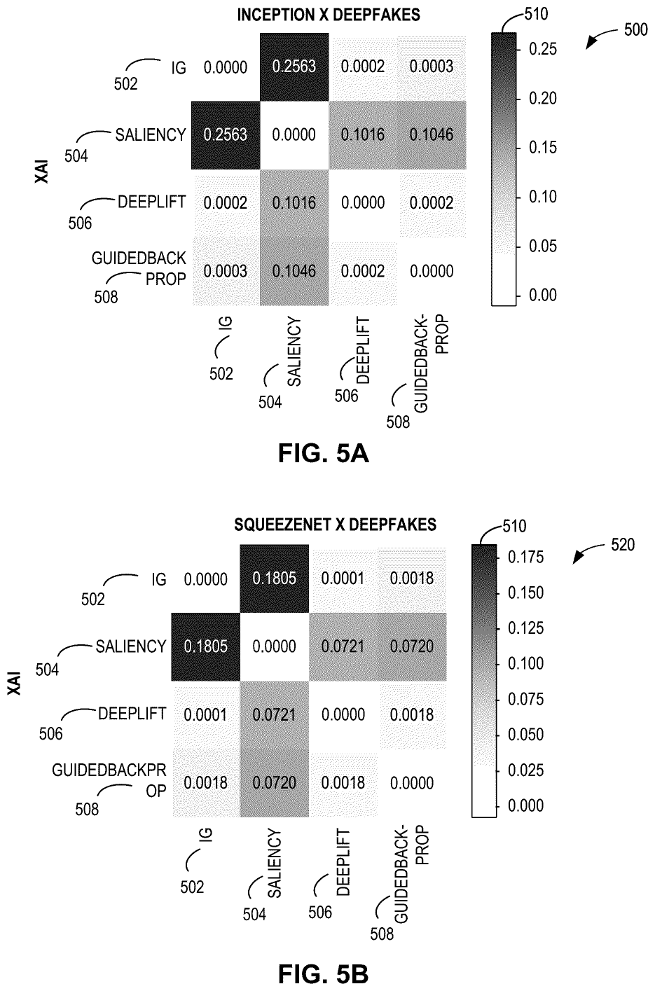

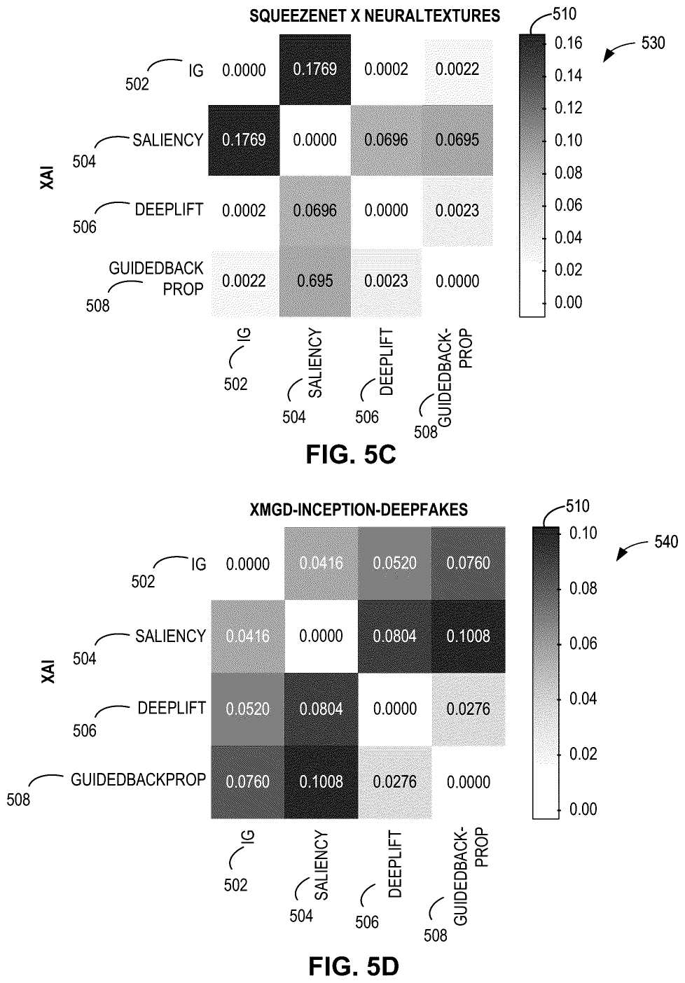

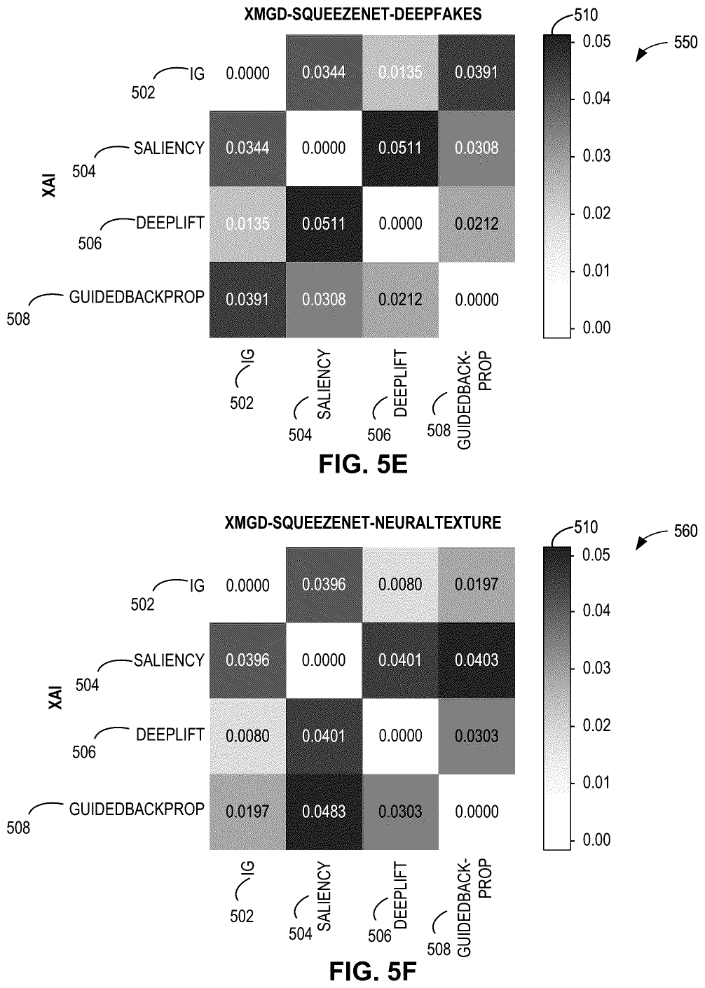

FIG. 4 illustrates example saliency maps 400 generated using seven detectors (e.g., Meso4 402, MesoInception4 404, SqueezeNet 406, mobilenetv3 408, ResNett18 410, and xception 412) and four saliency XAI-based methods (e.g., DeepLift 416, GuidedBackprop 418, IG 420, Saliency 422) for a specific frame. In the example of FIG. 4, the columns represent detectors and the rows represent the XAI methods, providing insight about all combinations. To evaluate the explainable multi-scale GMM distance (XGMD) based on preserved correlations of detectors/generators, saliencies are observed in the example of FIG. 4 based on two different detectors and two different dataset generators. For example, the FaceForensics++ dataset can be used to select detectors (e.g., as SqueezeNet, Inception, etc.) and generators (e.g., Deepfakes, NeuralTextures, etc.). Then, the saliency maps of single-generator trained models of these combinations are compared using KL divergence and the disclosed XMGD metric, as shown in more detail in connection with FIGS. 5A-5F. For example, as shown in connection with FIGS. 5A-5F, KL-divergence comparisons are not informative (e.g., as shown in FIGS. 5A-5C), while XMGD comparisons show variety (e.g., as shown in FIGS. 5D-5F). In some examples, pair-wise correlations of XMGD scores in the second row of FIG. 4 can be identified, assuming that same detector and same generator comparisons will surface as high correlations. For example, an evaluation of Deepfakes+SqueezeNet (e.g., middle of the row) and Deepfakes+Inception (e.g., left side of the row) shows a correlation of 0.813, an evaluation of Deepfakes+SqueezeNet and NeuralTextures+SqueezeNet (e.g., right side of the row) shows a correlation of 0.810, whereas the pair without common components shows a correlation of only 0.742. As such, these results indicate that correlations of detectors/generator are preserved when using the XMGD metric disclosed herein.

FIG. 5A illustrates an example first saliency map 500 generated using a first detector (Inception) and a first generator (Deepfakes) when evaluated using KL-divergence scores. As described in connection with FIGS. 3A-3C, the saliencies in the examples of FIGS. 5A-5F are aggregated over four different XAI-based methods (e.g., IG 502, Saliency 504, Deeplift 506, and Guidedback prop 508, which are assessed using distance comparison 510). For example, FIG. 5B illustrates an example second saliency map 520 generated using a second detector (SqueezeNet) and a first generator (Deepfakes) when evaluated using KL-divergence scores, and FIG. 5C illustrates an example third saliency map 530 generated using a second detector (SqueezeNet) and a second generator (NeuralTextures) when evaluated using KL-divergence scores. While FIGS. 5A-5C focus on single detector and generator saliency maps 500, 520, 530 generated by the four XAI methods as compared by using KL divergence, FIGS. 5D-5F focus on single detector and generator saliency maps 540, 550, 560 generated by the four XAI methods as compared by using the XMGD metric, with the XMGD metric showing higher correlation when the generator or detector is preserved. For example, FIG. 5D illustrates an example fourth saliency map 540 generated using a first detector (Inception) and a first generator (Deepfakes) when evaluated using the XGMD, FIG. 5E illustrates an example fifth saliency map 550 generated using a second detector (SqueezeNet) and a first generator (Deepfakes) when evaluated using the XGMD metric, and FIG. 5F illustrates an example sixth saliency map 560 generated using a second detector (SqueezeNet) and a second generator (NeuralTextures) when evaluated using the XGMD metric. XMGD is shown to be less sensitive to individual pixel and/or input saliency anomalies, making this metric more robust as a similarity measure for explainability.

In particular, the XMGD metric fits to a higher-order distribution (e.g., a GMM), unlike KL divergence, which relies on discrete, pixel-level calculations. In addition, XMGD is less sensitive to dataset size, especially for small datasets, overcoming poor convergence properties associated with Fréchet distance-based measures. As such, the XMGD metric disclosed herein can be used to analyze and quantify any model or dataset similarity. Given that XGMD models saliency to high-order probability distributions, this metric is more robust to noise and does not suffer from poor convergence properties, unlike other XAI-based comparison methods. As demonstrated empirically in the examples disclosed herein using a large number of models and datasets applied for deepfake detection, the XGMD metric can be used to identify fine-grain, XAI-based similarity and/or dissimilarity distinctions, sufficiently differentiating this metric from traditional methods.

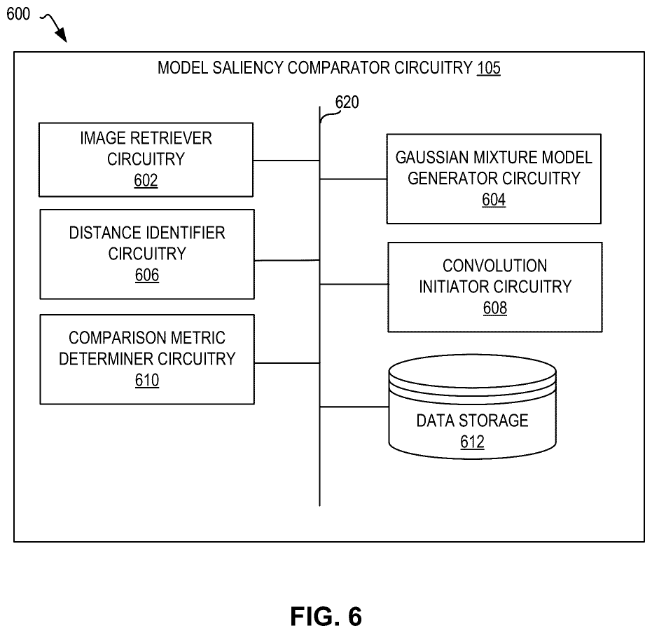

FIG. 6 is a block diagram 600 of an example implementation of the model saliency comparator circuitry 105 of FIGS. 1A-1B. The model saliency comparator circuitry 105 of FIGS. 1A-1B may be instantiated (e.g., creating an instance of, bring into being for any length of time, materialize, implement, etc.) by programmable circuitry such as a Central Processing Unit (CPU) executing first instructions. Additionally or alternatively, the model saliency comparator circuitry 105 of FIGS. 1A-1B may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 6 may, thus, be instantiated at the same or different times. Some or all of the circuitry of FIG. 6 may be instantiated, for example, in one or more threads executing concurrently on hardware and/or in series on hardware. Moreover, in some examples, some or all of the circuitry of FIG. 6 may be implemented by microprocessor circuitry executing instructions and/or FPGA circuitry performing operations to implement one or more virtual machines and/or containers.

In the example of FIG. 6, the model saliency comparator circuitry 105 of FIGS. 1A-1B includes example image retriever circuitry 602, example Gaussian mixture model (GMM) generator circuitry 604, example distance identifier circuitry 606, example convolution initiator circuitry 608, example comparison metric determiner circuitry 610, and example data storage 612. In the example of FIG. 6, the image retriever circuitry 602, Gaussian mixture model (GMM) generator circuitry 604, distance identifier circuitry 606, convolution initiator circuitry 608, comparison metric determiner circuitry 610, and data storage 612 are in communication via an example bus 620.

The image retriever circuitry 602 identifies input images associated with an image dataset. For example, the image retriever circuitry 602 identifies an image dataset (e.g., image dataset 102, 104 of FIG. 1A) for processing using the model saliency comparator circuitry 105. In some examples, the image retriever circuitry 602 identifies at least two sets of saliency images. In some examples, the image retriever circuitry 602 identifies aggregations of saliency images. The image retriever circuitry 602 identifies a mean, per-pixel saliency across the set of saliency images based on a min-max normalization. In some examples, the image retriever circuitry 602 generates saliency maps (e.g., saliency map(s) 114, 116) based on saliency models (e.g., saliency model(s) 106, 108). The image retriever circuitry 602 then projects the processed saliency maps to a unit grid (e.g., saliency map(s) 114, 116 are projected to unit grid(s) 122, 124), as described in more detail in connection with FIG. 1A.

The Gaussian mixture model (GMM) generator circuitry 604 trains a data weighted GMM to fit each saliency image retrieved using the image retriever circuitry 602. For example, the GMM generator circuitry 604 transforms each saliency image into a corresponding dataset in the input pixel space. In examples disclosed herein, the GMM generator circuitry 604 duplicates data points in correspondence with data weights (e.g., using a tunable binning parameter). In some examples, the GMM generator circuitry 604 identifies a first GMM (e.g., a first GMM defined using P) and a second GMM (e.g., a second GMM defined using Q) to fit the weighted data GMMs to processed saliency maps (e.g., generating Gaussian mixture model(s) 130, 132), as described in more detail in connection with FIG. 1A.

The distance identifier circuitry 606 generates a calculation of 2-Wasserstein distance(s) based on the weighted-data GMMs (e.g., corresponding to the distance calculation 134 of FIG. 1A). In examples disclosed herein, the distance identifier circuitry 606 identifies the 2-Wasserstein distance(s) in accordance with Equations 1 and/or 2 to determine an explainability-forward similarity between the saliences (e.g., based on a measured distance between two distributions). For example, the distance identifier circuitry 606 calculates the mixed 2-Wasserstein distance(s) (e.g., MW²(P, Q)) between the first GMM and the second GMM (e.g., one pair for each input scale) to quantify saliency similarity.

The convolution initiator circuitry 608 performs convolution operations to generate a more fine-grained saliency comparison metric capturing spatial properties. For example, the convolution initiator circuitry 608 determines the mixed 2-Wasserstein distance(s) across l spatial scales (e.g., using l−1 and two-dimensional (2D) convolutions with defined kernel sizes, as described in connection with FIG. 1B). In some examples, the convolution initiator circuitry 608 identifies kernel sizes used in the convolution operation for capturing different spatial scales in the saliency map for comparison (e.g., depending on the desired robustness of the saliency comparison measure).

The comparison metric determiner circuitry 610 identifies the final explainable multi-scale GMM distance (XMGD) based on an average of the distances from all levels of distances between and/or among distributions. For example, the comparison metric determiner circuitry 610 identifies the XMGD score output (e.g., XMGD score output 160 of FIG. 1B) based on GMM fittings performed for each available spatial scale (e.g., using single unit grid output(s) 154, 156, 158 of FIG. 1B) and the identification of an average 2-Wasserstein distance across the spatial scales. As such, the final XMGD score is based on a weighted sum of the multi-scale distances.

The data storage 612 can be used to store any information associated with the image retriever circuitry 602, the Gaussian mixture model (GMM) generator circuitry 604, the distance identifier circuitry 606, the convolution initiator circuitry 608, and/or the comparison metric determiner circuitry 610. The example data storage 612 of the illustrated example of FIG. 6 can be implemented by any memory, storage device and/or storage disc for storing data such as flash memory, magnetic media, optical media, etc. Furthermore, the data stored in the example data storage 612 can be in any data format such as binary data, comma delimited data, tab delimited data, structured query language (SQL) structures, image data, etc.

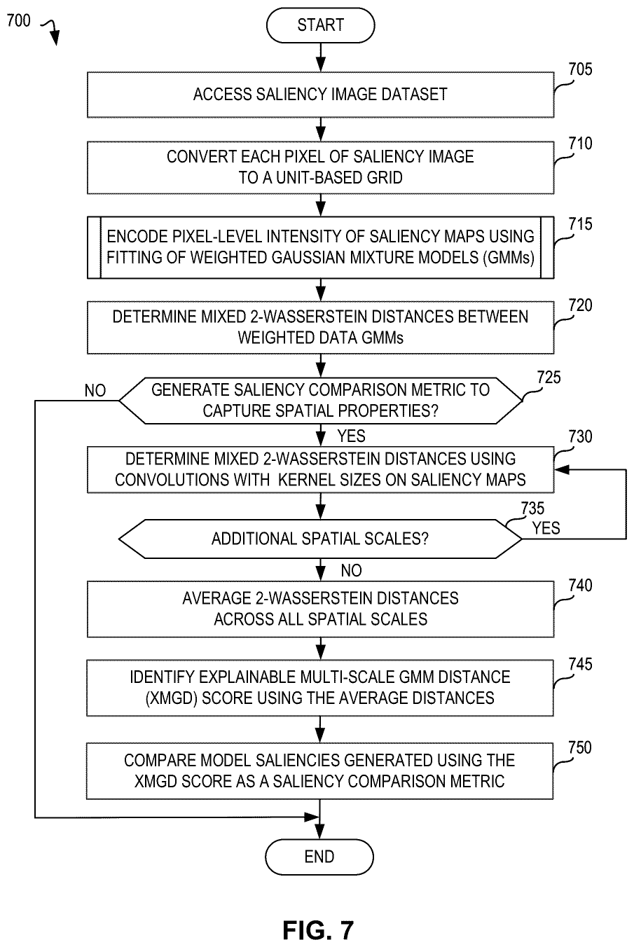

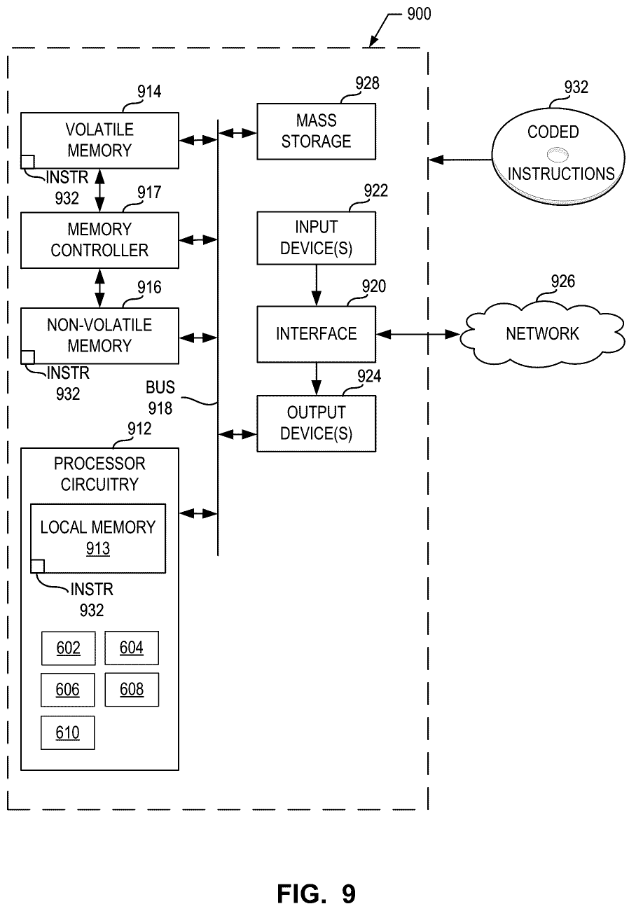

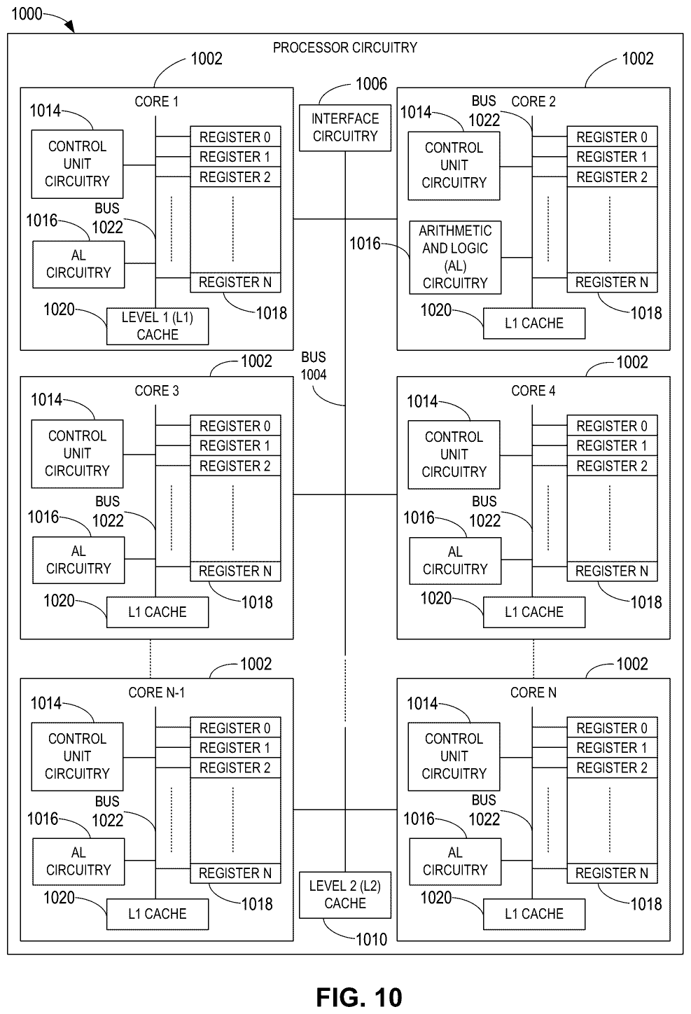

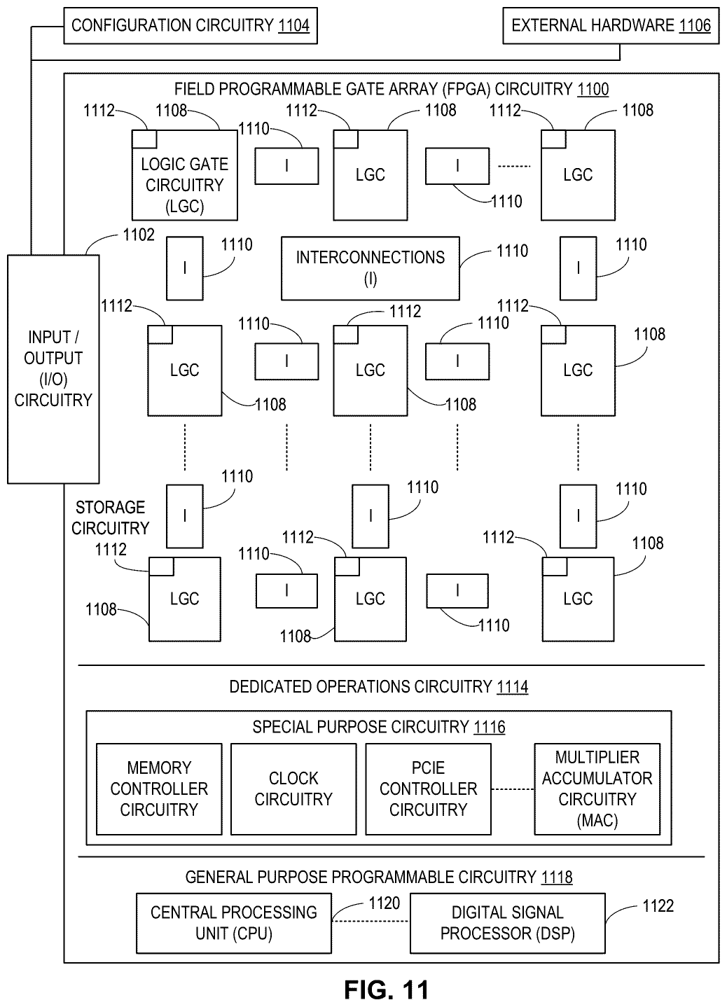

In some examples, the apparatus includes means for image retrieval. For example, the means for image retrieval may be implemented by image retriever circuitry 602. In some examples, the image retriever circuitry 602 may be instantiated by programmable circuitry such as the example programmable circuitry 912 of FIG. 9. For instance, the image retriever circuitry 602 may be instantiated by the example microprocessor 1000 of FIG. 10 executing machine executable instructions such as those implemented by at least block 705 of FIG. 7. In some examples, the image retriever circuitry 602 may be instantiated by hardware logic circuitry, which may be implemented by an ASIC, XPU, or the FPGA circuitry 1100 of FIG. 11 structured to perform operations corresponding to the machine readable instructions. Additionally or alternatively, the image retriever circuitry 602 may be instantiated by any other combination of hardware, software, and/or firmware. For example, the image retriever circuitry 602 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for Gaussian mixture model generation. For example, the means for Gaussian mixture model generation may be implemented by Gaussian mixture model (GMM) generator circuitry 604. In some examples, the GMM generator circuitry 604 may be instantiated by programmable circuitry such as the example programmable circuitry 912 of FIG. 9. For instance, the GMM generator circuitry 604 may be instantiated by the example microprocessor 1000 of FIG. 10 executing machine executable instructions such as those implemented by at least block 715 of FIG. 7. In some examples, the GMM generator circuitry 604 may be instantiated by hardware logic circuitry, which may be implemented by an ASIC, XPU, or the FPGA circuitry 1100 of FIG. 11 structured to perform operations corresponding to the machine readable instructions. Additionally or alternatively, the GMM generator circuitry 604 may be instantiated by any other combination of hardware, software, and/or firmware. For example, the GMM generator circuitry 604 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for identifying a distance. For example, the means for identifying a distance may be implemented by distance identifier circuitry 606. In some examples, the distance identifier circuitry 606 may be instantiated by programmable circuitry such as the example programmable circuitry 912 of FIG. 9. For instance, the distance identifier circuitry 606 may be instantiated by the example microprocessor 1000 of FIG. 10 executing machine executable instructions such as those implemented by at least block 720 of FIG. 7. In some examples, the distance identifier circuitry 606 may be instantiated by hardware logic circuitry, which may be implemented by an ASIC, XPU, or the FPGA circuitry 1100 of FIG. 11 structured to perform operations corresponding to the machine readable instructions. Additionally or alternatively, the distance identifier circuitry 606 may be instantiated by any other combination of hardware, software, and/or firmware. For example, the distance identifier circuitry 606 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for initiating a convolution. For example, the means for initiating a convolution may be implemented by convolution initiator circuitry 608. In some examples, the convolution initiator circuitry 608 may be instantiated by programmable circuitry such as the example programmable circuitry 912 of FIG. 9. For instance, the convolution initiator circuitry 608 may be instantiated by the example microprocessor 1000 of FIG. 10 executing machine executable instructions such as those implemented by at least block 730 of FIG. 7. In some examples, the convolution initiator circuitry 608 may be instantiated by hardware logic circuitry, which may be implemented by an ASIC, XPU, or the FPGA circuitry 1100 of FIG. 11 structured to perform operations corresponding to the machine readable instructions. Additionally or alternatively, the convolution initiator circuitry 608 may be instantiated by any other combination of hardware, software, and/or firmware. For example, the convolution initiator circuitry 608 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for determining a comparison metric. For example, the means for determining a comparison metric may be implemented by comparison metric determiner circuitry 610. In some examples, the metric determiner circuitry 610 may be instantiated by programmable circuitry such as the example programmable circuitry 912 of FIG. 9. For instance, the metric determiner circuitry 610 may be instantiated by the example microprocessor 1000 of FIG. 10 executing machine executable instructions such as those implemented by at least block 750 of FIG. 7. In some examples, the metric determiner circuitry 610 may be instantiated by hardware logic circuitry, which may be implemented by an ASIC, XPU, or the FPGA circuitry 1100 of FIG. 11 structured to perform operations corresponding to the machine readable instructions. Additionally or alternatively, the metric determiner circuitry 610 may be instantiated by any other combination of hardware, software, and/or firmware. For example, the metric determiner circuitry 610 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the model saliency comparator circuitry 105 is illustrated in FIG. 6, one or more of the elements, processes and/or devices illustrated in FIG. 6 may be combined, divided, re-arranged, omitted, eliminated and/or implemented in any other way. Further, the example image retriever circuitry 602, the example Gaussian mixture model generator circuitry 604, the example distance identifier circuitry 606, the example convolution initiator circuitry 608, the example comparison metric determiner circuitry 610, and/or, more generally, the example model saliency comparator circuitry 105 of FIGS. 1A-1B may be implemented by hardware, software, firmware and/or any combination of hardware, software and/or firmware. Thus, for example, any of the example image retriever circuitry 602, the example Gaussian mixture model generator circuitry 604, the example distance identifier circuitry 606, the example convolution initiator circuitry 608, the example comparison metric determiner circuitry 610, and/or, more generally, the example model saliency comparator circuitry 105 of FIGS. 1A-1B could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s), ASIC(s)), programmable logic device(s) (PLD(s)), and/or field programmable logic device(s) (FPLD(s)) such as FPGAs. Further still, the model saliency comparator circuitry 105 of FIGS. 1A-1B may include one or more elements, processes, and/or devices in addition to, or instead of, those illustrated in FIG. 6, and/or may include more than one of any or all of the illustrated elements, processes and devices.

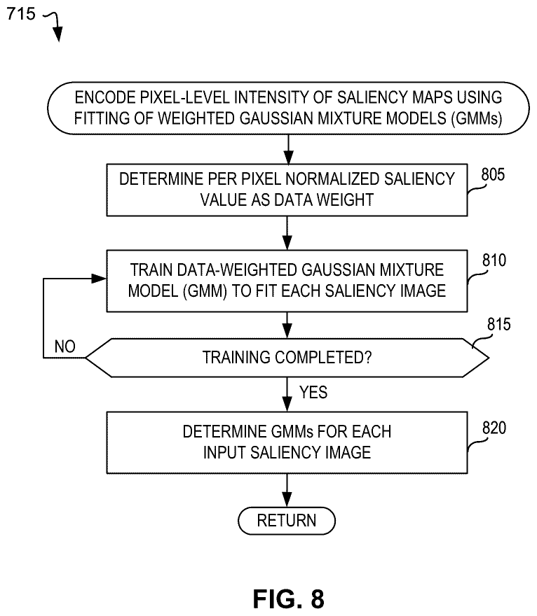

Flowcharts representative of example machine readable instructions, which may be executed by programmable circuitry to implement and/or instantiate the model saliency comparator circuitry 105 of FIGS. 1A-1B and/or representative of example operations which may be performed by programmable circuitry to implement and/or instantiate the model saliency comparator circuitry 105, are shown in FIGS. 7-8. The machine readable instructions may be one or more executable programs or portion(s) of one or more executable programs for execution by programmable circuitry, such as the programmable circuitry 912 shown in the example processor platform 900 discussed below in connection with FIG. 9 and/or may be one or more function(s) or portion(s) of functions to be performed by the example programmable circuitry (e.g., an FPGA) discussed below in connection with FIGS. 10 and/or 11. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 7-8, many other methods of implementing the example model saliency comparator circuitry 105 of FIGS. 1A-1B may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 7-8 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 7 is a flowchart representative of example machine readable instructions and/or example operations 700 that may be executed, instantiated, and/or performed by programmable circuitry to implement the example model saliency comparator circuitry 105 of FIGS. 1A-1B. The machine-readable instructions and/or the operations 700 of FIG. 7 begin at block 705, at which the image retriever circuitry 602 accesses a saliency image dataset. For example, the image retriever circuitry 602 retrieves images associated with the saliency image dataset 102, 104 of FIG. 1A. In some examples, the image retriever circuitry 602 converts each pixel of the saliency image to a unit-based grid, at block 710. For example, the image retriever circuitry 602 projects the processed saliency maps to a unit grid (e.g., [0,1]×[0,1]). The Gaussian mixture model generator circuitry 604 proceeds to encode pixel-level intensity of saliency maps using fitting of weighted Gaussian mixture models (GMMs), at block 715. For example, as described in more detail in connection with FIG. 8, the Gaussian mixture model generator circuitry 604 trains a data weighted GMM to fit each saliency image. Once the training is complete, the distance identifier circuitry 606 determines mixed 2-Wasserstein distances between weighted data GMMs, at block 720. For example, the distance identifier circuitry 606 generates a calculation of 2-Wasserstein distance(s) based on the weighted-data GMMs. Subsequently, the convolution initiator circuitry 608 determines whether to generate a saliency comparison metric to capture spatial properties, at block 725.

To proceed with the generation of the saliency comparison metric, the convolution initiator circuitry 608 determines mixed 2-Wasserstein distance(s) using convolutions with kernel sizes on saliency maps, at block 730. For example, the convolution initiator circuitry 608 uses different kernel sizes (e.g., 3×3, 5×5, and/or 7×7 kernel sizes) to capture different spatial scales in the saliency map(s) for comparison. If the convolution initiator circuitry 608 determines additional spatial scales, at block 735, the convolution initiator circuitry 608 proceeds to determine additional 2-Wasserstein distance(s) using convolutions. Once all desired spatial scales are captured, the comparison metric determiner circuitry 610 averages the 2-Wasserstein distance(s) across all the spatial scales, at block 740. The comparison metric determiner circuitry 610 identifies the explainable multi-scale GMM distance (XMGD) score using the average distances, at 745. Subsequently, the comparison metric determiner circuitry 610 compares the model saliencies generated using the XMGD score as a saliency comparison metric, at block 750. The XMGD-based metric disclosed herein provides distinct advantages over conventional visual-XAI metrics. For example, the XMGD is less sensitive to individual input and/or pixel saliency intensities and thus more robust as an explainable similarity measure than alternative metrics. Additionally, XMGD is not sensitive to dataset size and therefore does not suffer from poor convergence properties (e.g., associated with smaller datasets). The XMGD metric also operates directly on saliency maps, without manipulating the input and/or the model. Finally, XMGD can enhance explainability across a large number of diverse use cases, including saliency comparisons for individual images, entire datasets, and/or cross-model analysis.

FIG. 8 is a flowchart representative of example machine readable instructions and/or example operations 800 that may be executed, instantiated, and/or performed by programmable circuitry to implement the example model saliency comparator circuitry 105 of FIGS. 1A-1B. The machine-readable instructions and/or the operations 800 of FIG. 8 begin at block 805, at which the model saliency comparator circuitry 105 encodes pixel-level intensity of saliency maps using fitting of weighted Gaussian mixture models (GMMs). In the example of FIG. 8, the Gaussian mixture model generator circuitry 604 determines per pixel normalized saliency values as data weights, at block 805. For example, the Gaussian mixture model generator circuitry 604 defines spatial saliency over the unit grid with duplicated points and performs a fitting of the GMM using the expectation-maximization (EM) algorithm for each of the input saliency images. For example, the Gaussian mixture model generator circuitry 604 trains the data-weighted GMM to fit each saliency image, at block 810. Once the Gaussian mixture model generator circuitry 604 identifies that the training is completed, at block 815, the Gaussian mixture model generator circuitry 604 determines the GMMs for each input saliency image, at block 820.

FIG. 9 is a block diagram of an example programmable circuitry platform 900 structured to execute and/or instantiate the example machine-readable instructions and/or the example operations of FIGS. 7-8 to implement the example model saliency comparator circuitry 105 of FIGS. 1A-1B. The programmable circuitry platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs microprocessors, CPUs, GPUs, DSPs, and/or microcontrollers from any desired family or manufacturer. The programmable circuitry 912 may be implemented by one or more semiconductor based (e.g., silicon based) devices. In this example, the processor circuitry 912 implements the image retriever circuitry 602, the Gaussian mixture model generator circuitry 604, the distance identifier circuitry 606, the convolution initiator circuitry 608, and the comparison metric determiner circuitry 610.

The programmable circuitry 912 of the illustrated example includes a local memory 913 (e.g., a cache, registers, etc.). The programmable circuitry 912 of the illustrated example is in communication with a main memory including a volatile memory 914 and a non-volatile memory 916 by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a track-pad, a trackball, an isopoint device, and/or a voice recognition system.

One or more output devices 924 are also connected to the interface circuitry 920 of the illustrated example. The output devices 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 900 of the illustrated example also includes one or more mass storage devices 928 to store software and/or data. Examples of such mass storage devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 932, which may be implemented by the machine readable instructions of FIGS. 7-8, may be stored in the mass storage device 928, in the volatile memory 914, in the non-volatile memory 916, and/or on at least one non-transitory computer readable storage medium such as a CD or DVD which may be removable.

FIG. 10 is a block diagram of an example implementation of the programmable circuitry 912 of FIG. 9. In this example, the programmable circuitry 912 of FIG. 9 is implemented by a microprocessor 1000. For example, the microprocessor 1000 may be a general purpose microprocessor (e.g., general purpose microprocessor circuitry). The microprocessor 1000 executes some or all of the machine readable instructions of the flowcharts of FIGS. 7-8 to effectively instantiate the circuitry of FIG. 6 logic circuits to perform the operations corresponding to those machine readable instructions. In some such examples, the circuitry of FIG. 6 is instantiated by the hardware circuits of the microprocessor 1000 in combination with the instructions. For example, the microprocessor 1000 may implement multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIGS. 7-8.

The cores 1002 may communicate by a first example bus 1004. In some examples, the first bus 1004 may implement a communication bus to effectuate communication associated with one(s) of the cores 1002. For example, the first bus 1004 may implement at least one of an Inter-Integrated Circuit (I2C) bus, a Serial Peripheral Interface (SPI) bus, a PCI bus, or a PCIe bus. Additionally or alternatively, the first bus 1004 may implement any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2_cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the L1 cache 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer-based operations. In other examples, the AL circuitry 1016 also performs floating-point operations. In yet other examples, the AL circuitry 1016 may include first AL circuitry that performs integer-based operations and second AL circuitry that performs floating point operations. In some examples, the AL circuitry 1016 may be referred to as an Arithmetic Logic Unit (ALU).

The registers 1018 are semiconductor-based structures to store data and/or instructions such as results of one or more of the operations performed by the AL circuitry 1016 of the corresponding core 1002. For example, the registers 1018 may include vector register(s), SIMD register(s), general purpose register(s), flag register(s), segment register(s), machine specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure including distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages.

The microprocessor 1000 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1000, in the same chip package as the microprocessor 1000 and/or in one or more separate packages from the microprocessor 1000.

FIG. 11 is a block diagram of another example implementation of the programmable circuitry of FIG. 9. In this example, the programmable circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1000 of FIG. 10 described above (which is a general purpose device that may be programmed to execute some or all of the machine readable instructions represented by the flowcharts of FIGS. 7-8 but whose interconnections and logic circuitry are fixed once fabricated), the FPGA circuitry 1100 of the example of FIG. 11 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 7-8. In particular, the FPGA 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 7-8. As such, the FPGA circuitry 1100 may be configured and/or structured to effectively instantiate some or all of the operations/functions corresponding to the machine readable instructions of the flowcharts of FIGS. 7-8 as dedicated logic circuits to perform the operations/functions corresponding to those software instructions in a dedicated manner analogous to an ASIC. Therefore, the FPGA circuitry 1100 may perform the operations/functions corresponding to the some or all of the machine readable instructions of FIGS. 7-8 faster than the general-purpose microprocessor can execute the same.

In the example of FIG. 11, the FPGA circuitry 1100 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain a binary file, which may be implemented by a bit stream, data, and/or machine-readable instructions, to configure the FPGA circuitry 1100, or portion(s) thereof. In some such examples, the configuration circuitry 1104 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1106 may be implemented by external hardware circuitry. For example, the external hardware 1106 may be implemented by the microprocessor 1000 of FIG. 10.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to at least some of the machine readable instructions of FIGS. 7-8 and/or other desired operations. The logic gate circuitry 1108 shown in FIG. 11 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations/functions. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example dedicated operations circuitry 1114. In this example, the dedicated operations circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the programmable circuitry 912 of FIG. 9, many other approaches are contemplated. For example, FPGA circuitry may include an on-board CPU, such as one or more of the example CPU 1120 of FIG. 11. Therefore, the programmable circuitry 912 of FIG. 9 may additionally be implemented by combining at least the example microprocessor 1000 of FIG. 10 and the example FPGA circuitry 1100 of FIG. 11. In some such hybrid examples, one or more cores 1102 of FIG. 11 may execute a first portion of the machine readable instructions represented by the flowchart(s) of FIGS. 7-8 to perform first operation(s)/function(s), the FPGA circuitry 1100 of FIG. 11 may be configured and/or structured to perform second operation(s)/function(s) corresponding to a second portion of the machine readable instructions represented by the flowcharts of FIGS. 7-8, and/or an ASIC may be configured and/or structured to perform third operation(s)/function(s) corresponding to a third portion of the machine readable instructions represented by the flowcharts of FIGS. 7-8.

It should be understood that some or all of the circuitry of FIG. 6 may, thus, be instantiated at the same or different times. For example, same and/or different portion(s) of the microprocessor 1000 of FIG. 10 may be programmed to execute portion(s) of machine-readable instructions at the same and/or different times. In some examples, same and/or different portion(s) of the FPGA circuitry 1100 of FIG. 11 may be configured and/or structured to perform operations/functions corresponding to portion(s) of machine-readable instructions at the same and/or different times.

In some examples, some or all of the circuitry of FIG. 6 may be instantiated, for example, in one or more threads executing concurrently and/or in series. For example, the microprocessor 1000 of FIG. 10 may execute machine readable instructions in one or more threads executing concurrently and/or in series. In some examples, the FPGA circuitry 1100 of FIG. 11 may be configured and/or structured to carry out operations/functions concurrently and/or in series. Moreover, in some examples, some or all of the circuitry of FIG. 6 may be implemented within one or more virtual machines and/or containers executing on the microprocessor 1000 of FIG. 10.

In some examples, the programmable circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the programmable circuitry 912 of FIG. 4 which may be in one or more packages. For example, the XPU may include a CPU (e.g., the microprocessor 1000 of FIG. 10, the CPU 1120 of FIG. 11, etc.) in one package, a DSP (e.g., the DSP 1122 of FIG. 11) in another package, a GPU in yet another package, and an FPGA (e.g., the FPGA circuitry 1100 of FIG. 11) in still yet another package.

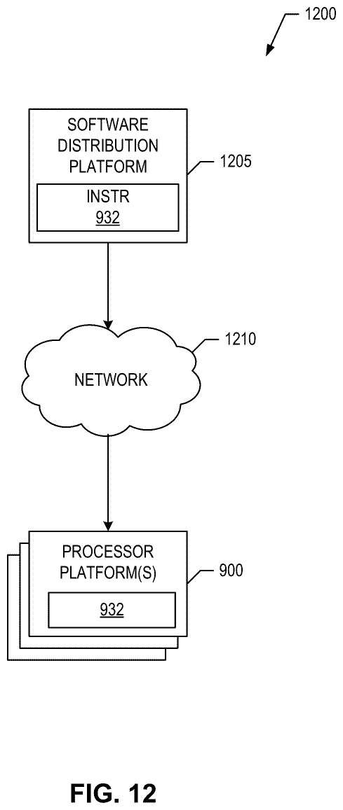

A block diagram illustrating an example software distribution platform 1205 to distribute software such as the example machine readable instructions 932 of FIG. 9 to other hardware devices (e.g., hardware devices owned and/or operated by third parties from the owner and/or operator of the software distribution platform) is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 932, which may correspond to the example machine readable instructions of FIGS. 7-8, as described above. The one or more servers of the example software distribution platform 905 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 932 from the software distribution platform 1205. For example, the software, which may correspond to the example machine readable instructions of FIGS. 7-8, may be downloaded to the example programmable circuitry platform 900, which is to execute the machine readable instructions 932 to implement the model saliency comparator circuitry 105 of FIGS. 1A-1B. In some examples, one or more servers of the software distribution platform 1205 periodically offer, transmit, and/or force updates to the software (e.g., the example machine readable instructions 932 of FIG. 9) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, methods, apparatus, and articles of manufacture disclosed herein provide an explainable multi-scale Gaussian mixture model distance. In examples disclosed herein, an explainability-based comparison metric (e.g., explainable multi-scale Gaussian mixture model (GMM) distance (XGMD) metric) is identified to compare model saliencies. In examples disclosed herein, flexible GMMs learn a high-order probability distribution in the input pixel space at multiple scales for each input saliency comparison. Compared to conventional visual Explainable Artificial Intelligence (XAI)-based metrics, in some examples the XGMD metric is less sensitive to individual input/pixel saliency anomalies and therefore more robust as an explainable similarity measure. XGMD metrics disclosed herein are also less sensitive to dataset size, given that known score-based methods show poor convergence properties on smaller datasets. In examples disclosed herein, the XGMD metric quantifies similarity and/or dissimilarity between different machine learning models and datasets based on the input saliency maps. Example methods and apparatus disclosed herein improve AI model explainability and trust for real-world use cases with synthetic data, including applications such as deepfake detection and/or analysis (e.g., identification of synthetic media that has been digitally manipulated, etc.).

Example methods, apparatus, systems, and articles of manufacture for an explainable multi-scale Gaussian mixture model distance are disclosed herein. Further examples and combinations thereof include the following:

Example 1 includes an apparatus, comprising interface circuitry, machine-readable instructions, and at least one processor circuit to be programmed by the machine-readable instructions to access a first saliency map and a second saliency map associated with an image dataset, encode pixel-level intensity of the first saliency map, encode pixel-level intensity of the second saliency map, generate a saliency comparison metric based on the pixel-level intensity of the first saliency map and the pixel-level intensity of the second saliency map, and compare spatial properties of the first saliency map and the second saliency map using the saliency comparison metric.

Example 2 includes the apparatus of example 1, wherein one or more of the at least one processor circuit is to train a weighted Gaussian mixture model to fit a saliency image, the saliency image associated with at least one of the first saliency map or the second saliency map.

Example 3 includes the apparatus of example 2, wherein one or more of the at least one processor circuit is to transform the saliency image into an input pixel space.

Example 4 includes the apparatus of one or more of examples 1-3, wherein one or more of the at least one processor circuit is to encode the pixel-level intensity of a first saliency image by fitting a first weighted Gaussian mixture model to the first saliency map and to encode the pixel-level intensity of a second saliency image by fitting a second weighted Gaussian mixture model to the second saliency image.

Example 5 includes the apparatus of one or more of examples 1-4, wherein one or more of the at least one processor circuit is to identify a 2-Wasserstein distance between the first weighted Gaussian mixture model and the second weighted Gaussian mixture model.

Example 6 includes the apparatus of one or more of examples 1-4, wherein one or more of the at least one processor circuit is to perform fitting of the first weighted Gaussian mixture model and the second weighted Gaussian mixture model across two or more spatial scales.

Example 7 includes the apparatus of one or more of examples 1-4, wherein one or more of the at least one processor circuit is to determine a per pixel normalized saliency value as a data weight for the first weighted Gaussian mixture model.

Example 8 includes the apparatus of one or more of examples 1-7, wherein one or more of the at least one processor circuit is to generate the saliency comparison metric based on an average of two or more 2-Wasserstein distances across two or more spatial scales.

Example 9 includes the apparatus of one or more of examples 1-8, wherein one or more of the at least one processor circuit is to identify the saliency comparison metric based on a convolution operation applied to at least one of the first saliency map or the second saliency map.

Example 10 includes at least one non-transitory machine-readable medium comprising machine-readable instructions to cause at least one processor circuit to at least access a first saliency map and a second saliency map associated with an image dataset, encode pixel-level intensity of the first saliency map, encode pixel-level intensity of the second saliency map, generate a saliency comparison metric based on the pixel-level intensity of the first saliency map and the pixel-level intensity of the second saliency map, and compare spatial properties of the first saliency map and the second saliency map using the saliency comparison metric.

Example 11 includes the at least one non-transitory machine-readable medium of example 10, wherein the machine-readable instructions are to cause one or more of the at least one processor circuit to train a weighted Gaussian mixture model to fit a saliency image, associated with the first saliency map.

Example 12 includes the at least one non-transitory machine-readable medium of one or more of examples 10-11, wherein the machine-readable instructions are to cause one or more of the at least one processor circuit to transform the saliency image into an input pixel space.

Example 13 includes the at least one non-transitory machine-readable medium of one or more of examples 10-12, wherein the machine-readable instructions are to cause one or more of the at least one processor circuit to encode the pixel-level intensity of the first saliency map by fitting a first weighted Gaussian mixture model to the first saliency map.

Example 14 includes the at least one non-transitory machine-readable medium of one or more of examples 10-13, wherein the machine-readable instructions are to cause one or more of the at least one processor circuit to identify a 2-Wasserstein distance between the first weighted Gaussian mixture model and a second weighted Gaussian mixture model.

Example 15 includes the at least one non-transitory machine-readable medium of one or more of examples 10-13, wherein the machine-readable instructions are to cause one or more of the at least one processor circuit to perform fitting of the first weighted Gaussian mixture model and a second weighted Gaussian mixture model across two or more spatial scales.

Example 16 includes the at least one non-transitory machine-readable medium of one or more of examples 10-13, wherein the machine-readable instructions are to cause one or more of the at least one processor circuit to determine a per pixel normalized saliency value as a data weight for the first weighted Gaussian mixture model.

Example 17 includes the at least one non-transitory machine-readable medium of one or more of examples 10-13, wherein the machine-readable instructions are to cause one or more of the at least one processor circuit to generate the saliency comparison metric based on an average of two or more 2-Wasserstein distances across two or more spatial scales.

Example 18 includes the at least one non-transitory machine-readable medium of one or more of examples 10-13, wherein the machine-readable instructions are to cause one or more of the at least one processor circuit to identify the saliency comparison metric based on a convolution operation applied to the first saliency map.

Example 19 includes the at least one non-transitory machine-readable medium of one or more of examples 10-18, wherein the machine-readable instructions are to cause one or more of the at least one processor circuit to use a tunable binning parameter to duplicate data points associated with a weighted Gaussian mixture model.

Example 20 includes the at least one non-transitory machine-readable medium of one or more of examples 10-19, wherein the machine-readable instructions are to cause one or more of the at least one processor circuit to fit a Gaussian mixture model using an expectation-maximization algorithm.

Example 21 includes a method, comprising accessing a first saliency map and a second saliency map associated with an image dataset, encoding pixel-level intensity of the first saliency map, encoding pixel-level intensity of the second saliency map, generating a saliency comparison metric based on the pixel-level intensity of the first saliency map and the pixel-level intensity of the second saliency map, and comparing spatial properties of the first saliency map and the second saliency map using the saliency comparison metric.

Example 22 includes the method of example 21, further training a weighted Gaussian mixture model to fit a saliency image, the saliency image associated with at least one of the first saliency map or the second saliency map.

Example 23 includes the method of one or more of examples 21-22, further transforming the saliency image into an input pixel space.

Example 24 includes the method of one or more of examples 21-23, further encoding the pixel-level intensity of a first saliency image by fitting a first weighted Gaussian mixture model to the first saliency map and to encode the pixel-level intensity of a second saliency image by fitting a second weighted Gaussian mixture model to the second saliency image.

Example 25 includes the method of one or more of examples 21-24, further identifying a 2-Wasserstein distance between the first weighted Gaussian mixture model and the second weighted Gaussian mixture model.

Example 26 includes the method of one or more of examples 21-24, further fitting of the first weighted Gaussian mixture model and the second weighted Gaussian mixture model across two or more spatial scales.

Example 27 includes the method of one or more of examples 21-24, further determining a per pixel normalized saliency value as a data weight for the first weighted Gaussian mixture model.

Example 28 includes the method of one or more of examples 21-27, further generating the saliency comparison metric based on an average of two or more 2-Wasserstein distances across two or more spatial scales.

Example 29 includes the method of one or more of examples 21-28, further identifying the saliency comparison metric based on a convolution operation applied to at least one of the first saliency map or the second saliency map.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus, comprising:
interface circuitry;
machine-readable instructions; and
at least one processor circuit to be programmed by the machine-readable instructions to:
access a first saliency map and a second saliency map associated with an image dataset;
encode pixel-level intensity of the first saliency map;
encode pixel-level intensity of the second saliency map;
generate a saliency comparison metric based on the pixel-level intensity of the first saliency map and the pixel-level intensity of the second saliency map; and
compare spatial properties of the first saliency map and the second saliency map using the saliency comparison metric.

2. The apparatus of claim 1, wherein one or more of the at least one processor circuit is to train a weighted Gaussian mixture model to fit a saliency image, the saliency image associated with at least one of the first saliency map or the second saliency map.

3. The apparatus of claim 2, wherein one or more of the at least one processor circuit is to transform the saliency image into an input pixel space.

4. The apparatus of claim 1, wherein one or more of the at least one processor circuit is to encode the pixel-level intensity of a first saliency image by fitting a first weighted Gaussian mixture model to the first saliency map and to encode the pixel-level intensity of a second saliency image by fitting a second weighted Gaussian mixture model to the second saliency image.

5. The apparatus of claim 4, wherein one or more of the at least one processor circuit is to identify a 2-Wasserstein distance between the first weighted Gaussian mixture model and the second weighted Gaussian mixture model.

6. The apparatus of claim 4, wherein one or more of the at least one processor circuit is to perform fitting of the first weighted Gaussian mixture model and the second weighted Gaussian mixture model across two or more spatial scales.

7. The apparatus of claim 4, wherein one or more of the at least one processor circuit is to determine a per pixel normalized saliency value as a data weight for the first weighted Gaussian mixture model.

8. The apparatus of claim 1, wherein one or more of the at least one processor circuit is to generate the saliency comparison metric based on an average of two or more 2-Wasserstein distances across two or more spatial scales.

9. The apparatus of claim 1, wherein one or more of the at least one processor circuit is to identify the saliency comparison metric based on a convolution operation applied to at least one of the first saliency map or the second saliency map.

10. At least one non-transitory machine-readable medium comprising machine-readable instructions to cause at least one processor circuit to at least:
access a first saliency map and a second saliency map associated with an image dataset;
encode pixel-level intensity of the first saliency map;
encode pixel-level intensity of the second saliency map;
generate a saliency comparison metric based on the pixel-level intensity of the first saliency map and the pixel-level intensity of the second saliency map; and
compare spatial properties of the first saliency map and the second saliency map using the saliency comparison metric.

11. The at least one non-transitory machine-readable medium of claim 10, wherein the machine-readable instructions are to cause one or more of the at least one processor circuit to train a weighted Gaussian mixture model to fit a saliency image, associated with the first saliency map.

12. The at least one non-transitory machine-readable medium of claim 11, wherein the machine-readable instructions are to cause one or more of the at least one processor circuit to transform the saliency image into an input pixel space.

13. The at least one non-transitory machine-readable medium of claim 10, wherein the machine-readable instructions are to cause one or more of the at least one processor circuit to encode the pixel-level intensity of the first saliency map by fitting a first weighted Gaussian mixture model to the first saliency map.

14. The at least one non-transitory machine-readable medium of claim 13, wherein the machine-readable instructions are to cause one or more of the at least one processor circuit to identify a 2-Wasserstein distance between the first weighted Gaussian mixture model and a second weighted Gaussian mixture model.

15. The at least one non-transitory machine-readable medium of claim 13, wherein the machine-readable instructions are to cause one or more of the at least one processor circuit to perform fitting of the first weighted Gaussian mixture model and a second weighted Gaussian mixture model across two or more spatial scales.

16. The at least one non-transitory machine-readable medium of claim 13, wherein the machine-readable instructions are to cause one or more of the at least one processor circuit to determine a per pixel normalized saliency value as a data weight for the first weighted Gaussian mixture model.

17. The at least one non-transitory machine-readable medium of claim 13, wherein the machine-readable instructions are to cause one or more of the at least one processor circuit to generate the saliency comparison metric based on an average of two or more 2-Wasserstein distances across two or more spatial scales.

18. The at least one non-transitory machine-readable medium of claim 13, wherein the machine-readable instructions are to cause one or more of the at least one processor circuit to identify the saliency comparison metric based on a convolution operation applied to the first saliency map.

19. The at least one non-transitory machine-readable medium of claim 10, wherein the machine-readable instructions are to cause one or more of the at least one processor circuit to use a tunable binning parameter to duplicate data points associated with a weighted Gaussian mixture model.

20. The at least one non-transitory machine-readable medium of claim 10, wherein the machine-readable instructions are to cause one or more of the at least one processor circuit to fit a Gaussian mixture model using an expectation-maximization algorithm.
